(19) United States
(12) Patent Application Publication
(10) Pub. No.: US 2013/0254880 A1
(43) Pub. Date: Sep. 26, 2013

(54) SYSTEM AND METHOD FOR CROWDSOURCING OF MOBILE APPLICATION REPUTATIONS

(71) Applicant: Matthew Brinkley, Portland, OR (US)

(72) Inventors: Dmitri Alperovitch, Gaithersburg, MD (US); Sven Krasser, Pasadena, CA (US); Matthew Brinkley, Portland, OR (US)

(73) Assignee: MCAFEE, INC., Santa Clara, CA (US)

(21) Appl. No.: 13/426,363

(22) Filed: Mar. 21, 2012

(51) Int. Cl. G06F 21/00

(52) U.S. Cl. 726/22

(57) ABSTRACT

A system and method in one embodiment includes modules for obtaining a collection of attributes of a mobile application, comparing one or more of the attributes with crowdsourced data associated with other mobile applications to determine one or more trustworthiness indicators, and calculating a reputation score based on the one or more trustworthiness indicators. More specific embodiments include a collection of attributes comprising a manifest, and an application behavior. Other embodiments include determining a suitable action based on the reputation score, such as changing a configuration of the mobile application, deleting the mobile application from a mobile device, generating a security alert on a display of the mobile device, etc.

### TECHNICAL FIELD

This disclosure relates in general to the field of computer networks and, more particularly, to a system and a method for crowdsourcing of mobile application reputations.

### BACKGROUND

The field of computer network security has become increasingly important and complicated in today's society. Computer network environments are configured for virtually every enterprise or organization, typically with multiple interconnected computers (e.g., end user computers, laptops, servers, printing devices, etc.). In many such enterprises, Information Technology (IT) administrators may be tasked with maintenance and control of the network environment, including executable software files (e.g., web application files) on hosts, servers, and other network computers. As the number of executable software files in a network environment increases, the ability to control, maintain, and remediate these files efficiently can become more difficult. Furthermore, computer and communications networks today encompass mobile devices such as smartphones, tablet computers and the like, which allow users to download and install applications on these devices quickly and with minimal oversight. However, unrestricted access to mobile resources and application programming interfaces by applications of an unknown or untrusted origin could result in damage to the user, the device, and the network, if not managed by suitable security architectures and network precautions. Thus, innovative tools are needed to assist IT administrators in the effective control and management of applications on mobile devices within computer and communication network environments.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram illustrating components of a system for crowdsourcing mobile application reputations according to an example embodiment;

FIG. 2 is a simplified block diagram illustrating additional details of the system for crowdsourcing mobile application reputations according to an example embodiment;

FIG. 3 is a simplified block diagram illustrating a system for crowdsourcing mobile application reputations according to another example embodiment;

FIG. 4 is a simplified flow-chart illustrating example operational steps that may be associated with an embodiment of the present disclosure;

FIG. 5 is a simplified flow-chart illustrating example operational steps that may be associated with embodiments of the present disclosure; and

FIG. 6 is a bar chart showing an example scenario of a number of applications against reputation score in accordance with this specification.

### DETAILED DESCRIPTION OF EXAMPLE EMBODIMENTS

### Overview

A system and method in example embodiments include modules for obtaining a collection of attributes of a mobile application, comparing one or more of the attributes with crowdsourced data associated with other mobile applications to determine one or more trustworthiness indicators, and calculating a reputation score based on the one or more trustworthiness indicators. More specific embodiments include a collection of attributes comprising a manifest, and an application behavior. Other embodiments include determining a suitable action based on the reputation score, such as changing a configuration of the mobile application, deleting the mobile application from a mobile device, generating a security alert on a display of the mobile device, etc.

### Example Embodiments

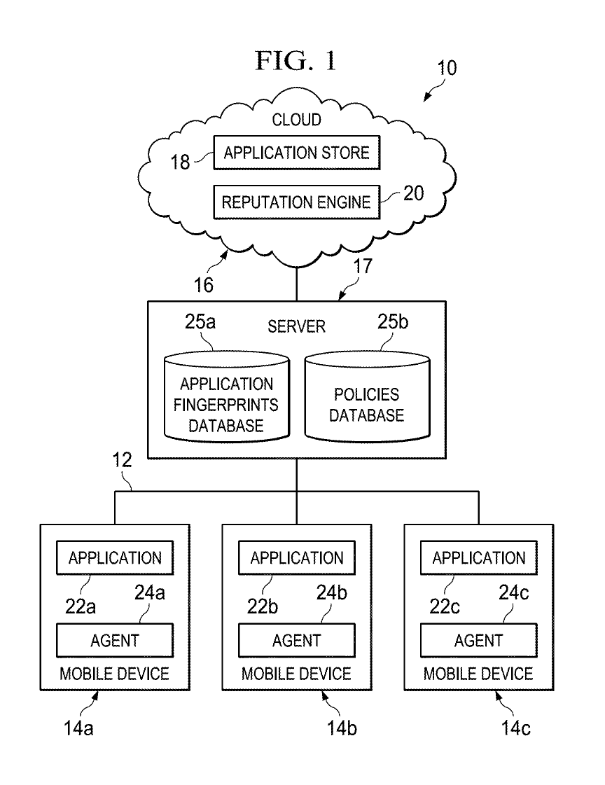

FIG. 1 is a simplified block diagram illustrating an example implementation of a system 10 for crowdsourcing of mobile application reputations. The exemplary environment illustrates a network 12 connecting one or more mobile devices 14a, 14b, and 14c with a cloud 16. In one example embodiment, mobile devices 14a-c may communicate with cloud 16 through server 17. Mobile devices (e.g., 14a-c), are inclusive of mobile phones, smart mobile phones (smartphones), e-book readers, tablets, iPads, personal digital assistants (PDAs), laptops or electronic notebooks, portable navigation systems, multimedia gadgets (e.g., cameras, video and/or audio players, etc.), gaming systems, other handheld electronic devices, and any other device, component, element, or object capable of initiating voice, audio, video, media, or data exchanges within system 10.

Mobile devices 14a-c may access mobile applications from one or more application stores 18 located in cloud 16. As used herein, “mobile applications” encompass application software that runs on (or is capable of running on) mobile devices and performs specific tasks for the mobile device's user. Mobile applications may include native applications pre-installed on the mobile device, such as address books, calendars, calculators, games, maps and Web browsers. Mobile applications may also be downloaded from various application stores 18. Application stores 18 encompass mobile application software distribution platforms such as Google® Android Market, Apple® App Store, Palm® Software Store and App Catalog, RIM® App World, etc.

Cloud 16 may comprise a reputation engine 20 for collecting and assessing mobile application reputations, also called herein as “reputation scores” (both terms may be interchangeably used throughout the Specification). A reputation score is a value (e.g., numeric, textual, pictorial, etc.) that denotes a relative level of trustworthiness of the mobile application on a spectrum (e.g., continuous or discrete) from benign (e.g., reputable) to malicious (e.g., non-reputable). Reputation score may indicate a probability that a mobile application is a malicious software. For example, mobile applications that have a high probability of being malicious may have a low reputation score. In one example scenario, a mobile application that automatically, and without authorization, turns on a camera and a microphone (or other recording device) of a mobile device may be deemed to be malicious. On the other hand, a mobile application that merely accesses the mobile device's processor and memory to facilitate a game of cards may be deemed to be benign.

Each mobile device 14a, 14b and 14c may be provisioned with one or more mobile applications (e.g., one or more respective applications 22a, 22b and 22c) and respective agents 24a, 24b and 24c. Agents 24a-c may monitor behavior and activities of any one or more mobile applications (e.g., 22a-c) on respective mobile devices 14a-c. Agents 24a-c may also access policies stored on respective mobile devices 14a-c to determine if mobile applications 22a-c violate any policy. Agents 24a-c may also manage activities of mobile applications 22a-c, for example, by preventing execution of one or more applications based on the respective reputation scores.

Reputation engine 20 may collect and aggregate an inventory of application fingerprints of substantially all mobile applications from a plurality of sources (e.g., mobile devices 14a-c, application store 18, etc.). As used herein, “application fingerprint” encompasses a collection of attributes of the application (e.g., obtained from the mobile application's manifest) and/or the application's behavior (e.g., application requests or actions, network activity, etc.) that uniquely identifies the application.

As used herein, an application manifest includes one or more files that contain details about a mobile application, such as unique application identification (ID) tag (e.g., iPhone® App ID number, Android Marketplace ID number, or other series of characters that can uniquely identify a mobile application); application certificate; application name; application capabilities such as camera activation, network connectivity, phone activation, geolocation, etc.; information about the application store from which the application was downloaded/installed (e.g., URL/IP and other identifying information); ports and protocols usable by the mobile application; application life span; a geographical origination of the mobile application; a day and/or time of a first and/or latest appearance of the mobile application on a mobile device; files and file hashes associated with the mobile application; other static analysis information (e.g., file size, unique or distinguishing human-readable strings from binary files associated with the application, interesting file header information, etc.) from the application's executable and configuration files; country/region where the mobile device is currently located; and geographical locations of subsequent appearances of the mobile application. The examples provided herein are merely for illustrative purposes and are not intended as limitations. Various other details relevant to the mobile application, the application store, and the application signer, may be included in the manifest within the broad scope of the present disclosure.

The application's behavior may include network activity; attack history; ports and protocols actually used by the mobile application; association with other known Internet Protocol (IP) addresses; application requests for resources; and application actions. It will be understood that these types of details are set forth herein for example purposes, and are not intended to be limiting in any manner.

According to the embodiment illustrated in FIG. 1, server 17 may be provisioned with an application fingerprints database 25a and policies database 25b. In an example embodiment, server 17 may be an enterprise server. In another embodiment, server 17 may be one or more intermediate servers. FIG. 1 showing mobile devices 14a-c communicating with cloud 16 through server 17 is merely representative. One or more servers may be used for one group of associated mobile devices (e.g., mobile devices on an enterprise, or having a common local communications carrier, etc.); and multiple enterprises or groups of associated mobile devices may connect to the cloud through their own one or more servers. Reputation engine 20 may access application fingerprints database 25a to determine a reputation score for a mobile application. Reputation engine 20 may access policies database 25b to identify a suitable action that may be taken with respect to the mobile application based on its reputation score.

In an example embodiment, the inventory may be collected through an enterprise mobility manager (EMM) of an enterprise network (e.g., McAfee® EMM). For example, an EMM could provide software applications installed on each mobile device to collect the mobile device's inventory and push it to a centralized or distributed repository. In another example embodiment, the inventory may be collected directly from mobile devices and other appropriate sources. Sources may include mobile devices, application stores, servers, web sites, etc. Reputation engine 20 in cloud 16 may crowdsource (e.g., obtain from an undefined plurality of sources rather than specific/identified sources) intelligence on proliferation of mobile applications and their capabilities and derive reputation scores for them based on the application fingerprint data in the inventory. As more information is collected in the inventory (e.g., from more mobile devices), application fingerprint data in the inventory may be more accurate leading to higher confidence in the calculated reputation score. In an example embodiment, each installed application on a mobile device (e.g., 14a-c) may be queried in cloud 16 by reputation engine 20, which can return respective mobile application reputations calculated based on proliferation of the application, its capabilities and longevity, and potentially augmented by manual research analysis.

According to embodiments of the present disclosure, crowdsourcing (e.g., from mobile devices) can enable data collection more efficiently and effectively than by other methods (e.g., crawling application stores, analyzing individual malware samples in isolation). For example, in some embodiments, data may be collected directly from user devices, rather than from other sources (e.g., application stores). In scenarios where the application store does not permit retrieving a copy of the application without purchase, or where numerous application stores quickly appear and disappear in a marketplace, crowdsourcing (e.g., from mobile devices) may enable efficient data collection for applications that have been downloaded and/or installed from such application stores.

Crowdsourced data from mobile devices can be used to calculate a reputation score of a mobile application. In example embodiments, crowdsourced data may be used to analyze various attributes of the mobile application to determine trustworthiness indicators, and reputation scores may be calculated based on the trustworthiness indicators. Trustworthiness indicators may include prevalence of the application, reputation of the application store from which the application was downloaded, reputation of the vendor signing the application (i.e., signer), predefined combination of capabilities of the application (e.g., capabilities of the application being analyzed and other similar applications), propagation factor of the application, origination of application, etc. Crowdsourced data could include attributes of other mobile applications that may be identical to the mobile application being analyzed, or may be similar with some significant differences that potentially indicate a malicious component. Thus, crowdsourcing can also help identify mobile applications that have been repackaged to include malware.

In instances where legitimate applications are repackaged (e.g., in subsequent versions) with malware, crowdsourcing may enable a determination that a particular application has been repackaged with malware and, accordingly, a determination of an appropriate reputation score for the repackaged application. A repackaged application can may have similar measurements to a legitimate application, while exhibiting other critical differences (e.g., different capabilities). For instance, the repackaged application may have a lower prevalence, leading to lower reputation score; comparisons of at least some of the data in the application's manifest to crowdsourced data may indicate red flags (e.g., an application with the same name but different capabilities as another application may raise a red flag). Further, crowdsourcing may indicate that an application's store and signer have reputations that are low, and the application's reputation score can be reduced accordingly.

In example embodiments, the reputation score may be calculated based on trustworthiness indicators of the mobile application, either alone or in combination. For example, reputation score may be calculated based on a prevalence of the application. A more widely used application and an application that has been in use for a longer time may be more likely to be non-malicious. Also, the fact that a user chose to download and install an application could be a tacit assertion by the user that the application is trustworthy and desirable. Conversely, a new application may be given a reduced reputation score, particularly if other factors (e.g., combinations of data indicating an application has been repackaged) indicate the application may be malicious.

An application store's reputation may also be considered in the calculation of a reputation score for an application associated with the application store. For example, reputations of various application stores may be determined by tracking externally available data (such as newspaper reports, financial filings, etc.), or deduced through detected malware (e.g., application stores that have historically hosted malware may be assigned a reduced reputation). Crowdsourcing can provide information indicating the application stores from which particular applications have been downloaded. Accordingly, the reputations of the indicated application stores can be considered when calculating reputation scores for the particular applications (e.g., an application downloaded from an application store with a poor reputation may be assigned a reduced reputation score).

In yet other example embodiments, the reputation score may be calculated based on capabilities of the mobile application. For example, an application may be assigned a lower reputation score if it asks for a large number of potentially abusable behavior permissions. Crowdsourcing in such scenarios may be used to help identify unusual combinations of permissions, or unexpected permissions (e.g., a purported game application sending unauthorized SMS messages). In yet other example embodiments, a reputation score may be calculated based on reputations of other applications from a signer (e.g., a vendor who digitally signs the application). For instance, if a signer has previously signed applications with low reputation scores, then any new applications with the same signer may be assigned a low reputation score. In yet other example embodiments, a combination of trustworthiness indicators and attributes may be used to calculate the reputation score. For example, prevalence and application behavior together with data from the manifest can be used to determine the reputation score of the mobile application.

Reputation engine 20 may forward the respective reputation scores to agents 24a-c, which may determine further action (e.g., changing configuration of applications 22a-c; deleting applications 22a-c from mobile devices 14a-c; generating security alerts on displays of mobile devices 14a-c; generating security beeps on speakers of mobile devices 14a-c; preventing execution of applications 22a-c; preventing download of the mobile application from application store 18; preventing access to resources in mobile device 14a; quarantining applications 22a-c; quarantining mobile device 14a; not taking any security action, etc.) based on the mobile application reputation.

The network environment illustrated in FIG. 1 may be generally configured or arranged to represent any communication architecture capable of electronically exchanging packets. In addition, the network may also be configured to exchange packets with other networks such as, for example, the Internet, or other LANs. Other common network elements (e.g., email gateways, web gateways, routers, switches, loadbalancers, firewalls, etc.), may also be provisioned in the network.

For purposes of illustrating the techniques of system 10, it is important to understand the activities and security concerns that may be present in a given network such as the network shown in FIG. 1. The following foundational information may be viewed as a basis from which the present disclosure may be properly explained. Such information is offered earnestly for purposes of explanation only and, accordingly, should not be construed in any way to limit the broad scope of the present disclosure and its potential applications.

Typical network environments, both in organizations (e.g., businesses, schools, government organizations, etc.) and in homes include a plurality of devices such as end user desktops, laptops, servers, network appliances, and the like, with each device having an installed set of executable software. Users in organizations and homes may also use mobile devices to connect to various wired and/or wireless networks. One difficulty users face when managing their devices in a network environment is ensuring that only trusted and approved executable software files are present on the devices. Although devices in a network may initially be configured with trusted and approved executable software, continuous efforts (both electronic and manual) are usually necessary to protect against unknown and/or malicious software. In particular, users may connect to a network using mobile devices, which may have vulnerabilities that hackers may use to spy on the users, or compromise secure information stored on servers and related networked devices.

Certain mobile applications may be unwanted, or even malicious, to a user or a network. Malicious software (malware) includes hostile, intrusive, or annoying programming (e.g., code, script, active content, etc.) that can disrupt or deny operation, gather information that leads to loss of privacy or exploitation, gain unauthorized access to system resources, and exhibit other abusive behavior. For example, a mobile application on a mobile phone could be remotely controlled, and configured to turn on the phone's camera and microphone, permitting spying. In another example, a mobile application may track a user's location and convey that information to unauthorized persons. In yet another example, malicious mobile applications may provide a pathway for unauthorized access to critical and proprietary information, inappropriate use of resources, business interruptions, fraud, and security breaches. Research indicates that rogue mobile applications (e.g., malware and spyware) are about to become a tremendous problem for the mobile security space.

Currently, solutions for identifying such rogue mobile applications generally exist in an enterprise space. Some existing solutions for malware detection use blacklisting. However, blacklisting solutions fail to detect and block day-zero and never-before-seen malware. Moreover, blacklisting is reactive and is not an effective solution to combat new and/or slightly modified malware. Other enterprise solutions employ a reputation system to identify malicious applications. For example, McAfee® Enterprise Mobility Management (EMM) software configures mobile devices to match corporate security policies and enforces compliance prior to network access. The enterprise solutions may manage a few or thousands of mobile devices over a geographically dispersed enterprise network, safeguarding against threats (i.e., malware and spyware) that originate via email, instant messaging, and Internet downloads. However, such current enterprise solutions are limited in scope. For example, reputation scores of applications may be based only on information obtained form mobile devices within the enterprise network. Malicious applications existing on mobile devices outside the enterprise network may be unknown, or may be characterized as benign inside the enterprise network (due to lack of historical information), until an attack occurs.

A system for crowdsourcing of mobile application reputations outlined by FIG. 1 can resolve these issues, among others. Embodiments of the present disclosure seek to vastly improve capabilities of existing technologies to allow for a more robust solution. Collection and analysis of reputation information may happen in the cloud (e.g., cloud 16) for scale, efficiency, and pervasiveness. Mobile devices may be configured to permit access from the cloud to their agents and applications for purposes of aggregating information for calculating mobile application reputations.

Knowledge gained from monitoring mobile application activity on any one mobile device may be aggregated and analyzed against information about similar activity obtained from other mobile devices (e.g., through crowdsourcing), and correlated with data from other vectors (e.g., file, web, message, network connections, and manual efforts) for substantially comprehensive information about the mobile application. Additionally, any threat or vulnerability may be temporal in nature (e.g., if a mobile application is interacting with an IP address that is temporarily compromised), and components of system 10 may modify the application's reputation score appropriately in real time to remediate the threat to the host mobile device. For example, reputation engine 20 may incorporate and adjust mobile application reputations with each additional data point. Thus, rogue/malicious mobile applications that attempt to test malware or do a “dry run” of an attack/spying activity may inadvertently alert system 10 of such activities.

Reputation engine 20 may determine a reputation score of mobile application 22a by evaluating one or more application fingerprints of mobile application 22a uploaded to reputation engine 20 by one or more sources. In an example embodiment, the aggregated application fingerprints may include information from various application manifests that can be evaluated to determine a reputation score. In another embodiment, the aggregated application fingerprints may include aggregated behaviors of the application that may also be evaluated to determine a reputation score of the mobile application. As more information about an application is reported or otherwise made available to reputation engine 20, a statistical confidence level of the reputation score may be higher.

An overall reputation score may be determined based upon the calculated probabilities and provided to agent 24a on mobile device 14a. Agent 24a may examine the mobile application reputation to determine what action should be taken based on the reputation score. Any suitable action could be taken, for example, changing configuration of application 22a; deleting application 22a from mobile device 14a; generating a security alert on a display of mobile device 14a; generating a security beep on a speaker of mobile device 14a; preventing execution of application 22a; preventing download of application 22a from application store 18; transmitting a security alert to application store 18; preventing access to resources in mobile device 14a; quarantining mobile application 22a; quarantining mobile device 14a; not taking any security action, etc.

Not shown in system 10 of FIG. 1 is hardware that may be suitably coupled to reputation engine 20 in the form of consoles, user interfaces, memory management units (MMU), additional symmetric multiprocessing (SMP) elements, peripheral component interconnect (PCI) bus and corresponding bridges, small computer system interface (SCSI)/integrated drive electronics (IDE) elements, etc. In addition, suitable modems, routers, base stations, wireless access points, and/or network adapters may also be included for allowing network access by components of system 10. Any suitable operating systems may also be configured in components of system 10 to appropriately manage the operation of hardware components therein. Components of system 10 may include any other suitable hardware, software, components, modules, interfaces, or objects that facilitate the operations thereof. This may be inclusive of appropriate algorithms and communication protocols that facilitate the crowdsourcing of mobile application reputation operations detailed herein. These elements, shown and/or described with reference to system 10 are intended for illustrative purposes and are not meant to imply architectural limitations. In addition, each element, including reputation engine 20, agents 24 and mobile devices 14, may include more or less components where appropriate and based on particular requirements.

System 10 may be adapted to provide crowdsourcing of mobile application reputation activities for electronic data (e.g., mobile application), which could be resident in memory of a mobile device, a computer or other electronic storage device. Information related to crowdsourcing of mobile application reputation activities can be suitably rendered, or sent to a specific location (e.g., mobile device 14, reputation engine 20, etc.), or simply stored or archived, and/or properly displayed in any appropriate format.

Network 12 represents networks, which can be a series of points or nodes of interconnected communication paths for receiving and transmitting packets of information that propagate through system 10. Network 12 offers communicative interfaces between any of the components of FIG. 1. Network 12 could be any local area network (LAN), wireless local area network (WLAN), wide area network (WAN), wireless wide area network (WWAN), metropolitan area network (MAN), wireless metropolitan area network (WMAN), wireless single hop or multi-hop network, virtual private network (VPN), Intranet, Extranet, or any other appropriate architecture or system that facilitates communications in a network environment. Network 12 may include any suitable communication link to reputation engine 20 such as wireless technologies (e.g., IEEE 802.11, 802.16, WiFi, Bluetooth, WiMax, DSRC, WiMAX, etc.), satellite, cellular technologies (e.g., 3G, 4G, etc.), etc., or any combination thereof. Network 12 may also include configurations capable of transmission control protocol/Internet protocol (TCP/IP) communications, user datagram protocol/IP (UDP/IP), or any other suitable protocol, where appropriate and based on particular needs.

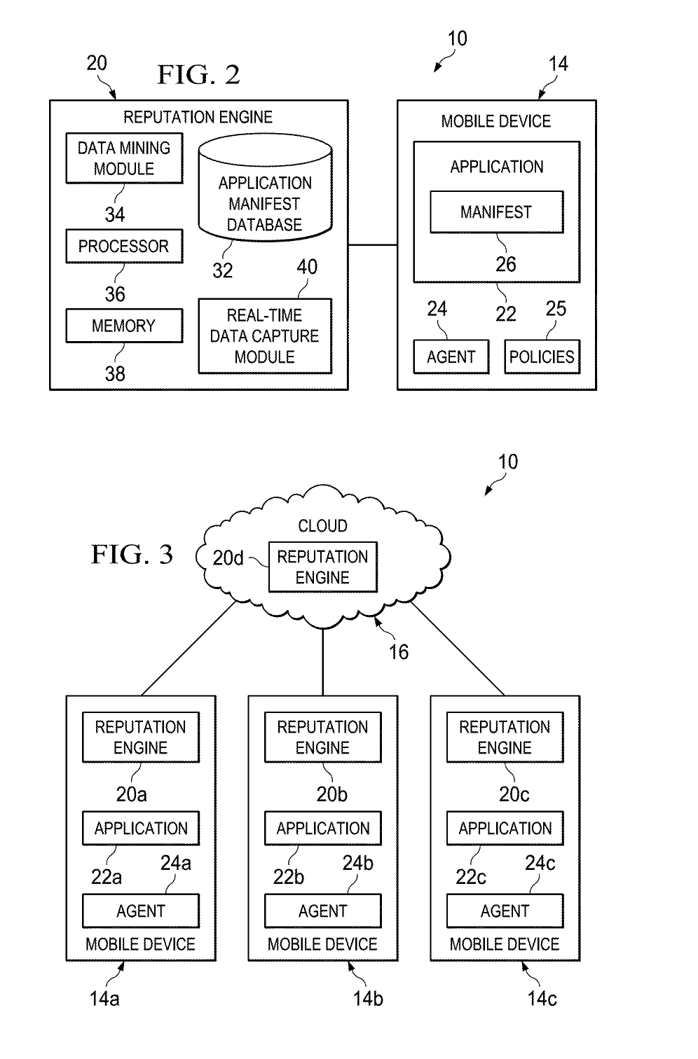

Turning to FIG. 2, FIG. 2 illustrates additional details of system 10. Reputation engine 20 may be in communication with mobile device 14. One or more applications 22 may be installed or otherwise available on mobile device 14. Applications 22 may include one or more manifests 26. In an example embodiment, a separate manifest may be uniquely associated with each one of applications 22. In another example embodiment, manifest 26 may aggregate information from multiple applications 22. In some embodiments, manifest 26 may comprise an XML document, while in other embodiments, manifest 26 may take any other suitable form. Mobile device 14 can use manifest 26 to allocate resources for application execution. For example, manifest 26 may specify that one of applications 22 can use a camera of the mobile device, co-location, etc.

Mobile device 14 may be provisioned with agent 24 that tracks applications 22 and applicable policies 25. In an example embodiment, agent 24 may include event detection capabilities, communication interfaces, policy manager, etc. In another example embodiment, agent 24 may include software capable of communicating with reputation engine 20 and carrying out instructions from policy managers, event detection components, etc. Agent 24 may be configured to receive queries or information from reputation engine 20. For example, reputation engine 20 may query agent 24 for a status of one or more applications 22. Agent 24 may provide application status to reputation engine 20 in response to the query. In another example, reputation engine 20 may provide agent 24 with a mobile application reputation of one of applications 22. In response, agent 24 may lookup a policy and determine a suitable action based on the mobile application reputation.

Mobile device 14 may be configured to send information to reputation engine 20 and/or permit reputation engine 20 to access information stored on mobile device 14. In an example embodiment, a user may provide permission to reputation engine 20 to access mobile device 14. In another example embodiment, mobile device 14 may be configured to communicate with reputation engine 20 using authentication protocols, for example, when a user signs up on an Internet site to access services provided by reputation engine 20.

Reputation engine 20 may comprise application manifest database 32, which may aggregate and store an inventory of application manifest information crowdsourced from a plurality of mobile devices (e.g., mobile device 14). A real-time data capture module 40 may be provisioned in reputation engine 20. In an example embodiment, real-time data capture module 40 may access mobile device 14 and capture information about activities of applications 22 in real-time, for example, from application manifest 26 and/or agent 24. In another example embodiment, agent 24 may send application behavior information to real-time data capture module 40 in reputation engine 20. Reputation engine 20 may aggregate application information in application manifest database 32 and real-time data capture module 40 in any appropriate format and based on suitable needs.

In an example scenario, if a new mobile application pops up in a particular geographic location (e.g., China) and it spreads like wildfire within hours (e.g., mobile application is downloaded and installed on several hundred mobile devices distributed in various geographic locations, such as United States, Australia, India, and Japan in a short span of time), such fast distribution is likely to be an indicator of malicious behavior, and its reputation score may be updated to reflect this characteristic. Application manifest database 32 may include information about the location and time of appearance of the application from the application manifests sent to reputation engine 20 from various mobile devices. Data mining module 34 may aggregate this information, analyze it, and determine that a propagation factor (i.e., how quickly the mobile application spreads to other mobile devices) of the mobile application is high, indicating possible malicious behavior.

In another example scenario, an application on a particular mobile device may initiate a spying action. Real-time data capture module 40 may recognize the spying action and consequently, reputation engine 20 may calculate an updated reputation score for the application. The updated reputation score may be distributed to all other mobile devices on which the application is installed, enabling respective agents to take suitable action.

A data mining module 34, processor 36 and memory 38 may be provisioned on reputation engine 20 to facilitate calculation of mobile application reputations. Data mining module 34 may extract relevant application fingerprints from application manifest database 32 and real time data capture module 40. Although data mining module 34 is illustrated as a part of reputation engine 20, data mining module 34 may be implemented in a variety of ways, such as through a stand-alone service in communication with reputation engine 20, a server application running partly or wholly on a secure server in a proprietary network, etc. Using processor 36 and memory 38, reputation engine 20 may calculate and/or update a mobile application reputation score for a mobile application from the information extracted by data mining module 34.

In an example scenario, mobile device 14 may be provisioned with a policy that applications on a network accessing pictures on mobile device 14 are not allowed to run. Agent 24 may track access by applications 22 to pictures on mobile device 14. For illustrative purposes, assume that an application in the network tries to access the pictures from one of the mobile devices on the network. Reputation engine 20 may become aware of the application action (e.g., through real-time data capture module 40). In response, reputation engine 20 may update a reputation score for the application. If the application is one of applications 22 in mobile device 14, agent 24 may access the updated reputation score, and take appropriate action against the application on mobile device 14. Thus, components of system 10 do not have to check and analyze a code of the application in every mobile device while the application tries to access the pictures. Instead, an action from a single source may be used to update a reputation score and permit other devices on the network to appropriately take action against the application.

Turning to FIG. 3, FIG. 3 illustrates a simplified block diagram of an embodiment of the present disclosure. System 10 may include mobile devices 14 (e.g., mobile devices 14a-c) that can communicate with cloud 16. Each mobile device 14a-c may be provisioned with respective reputation engines 20a-c. In addition, cloud 16 may also be provisioned with reputation engine 20d. Each mobile device 14a-c may also be provisioned with one or more mobile applications 22a-c respectively, and respective agents 24a-c.

Reputation engines 20a-c may aggregate mobile application information and calculate respective reputation scores for mobile applications 22 installed on the respective mobile devices 14a-c. For example, reputation engine 20a may compute mobile application reputations for mobile applications 22a on mobile device 14a. Likewise, reputation engine 20b may compute mobile application reputations for mobile applications 22b on mobile device 14b and so on. In an example embodiment, reputation engine 22d residing in cloud 16 may aggregate mobile application reputations from reputation engines 22a-c, and reconcile the scores. For example, reputation engine 20a may provide a reputation score for a mobile application indicating that the mobile application is benign. However, reputation engine 20c may provide a reputation score for the same mobile application, indicating that the mobile application is malicious.

Reputation engine 20d may reconcile the conflicting information and send updated reputation scores to reputation engines 20a-c. Thus, for example, even if mobile device 14a loses connectivity to cloud 16, reputation engine 20a residing on mobile device 14a may be able to calculate updated mobile application reputation for one of applications 22a in real time. When mobile device 14a regains connectivity to cloud 16, reputation engine 20a may send the updated mobile application reputation to reputation engine 20d. In another embodiment, reputation engine 20d may calculate mobile application reputations and push the information to individual reputation engines 20a-c.

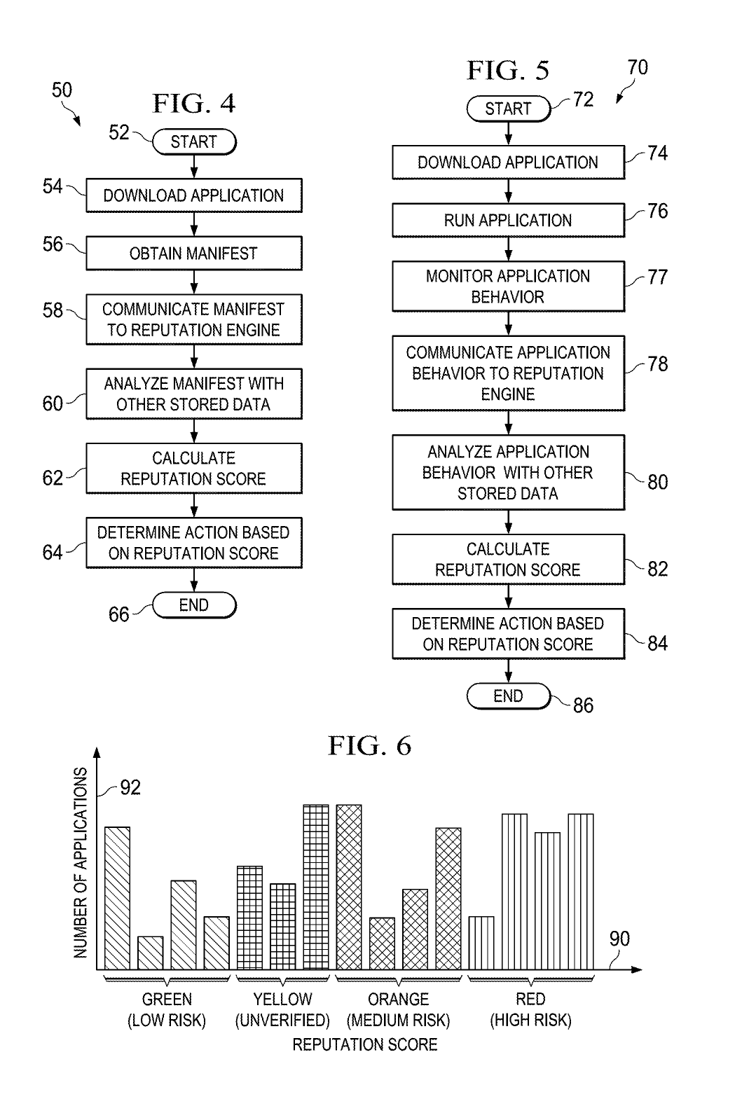

Turning to FIG. 4, FIG. 4 is a simplified flow-chart illustrating example operational steps associated with embodiments according to the present disclosure. Embodiments of the present disclosure can calculate reputation scores for mobile applications from manifests of mobile applications. A method 50 for calculating a reputation score of a mobile application may begin in step 52, when a mobile device (e.g., mobile device 14) accesses application store 18, or other source of mobile applications. In step 54, mobile device 14 may download application 22. In step 56, application manifest 26 may be obtained. In an example embodiment, manifest 26 may be downloaded with application 22. In another example embodiment, mobile device 14 may extract relevant information from application 22 and populate manifest 26 with the extracted information. In step 58, manifest 26 may be communicated to reputation engine 20. In an example embodiment, reputation engine 20 may access manifest 26 and obtain information stored therein. In another example embodiment, mobile device 14 may send manifest 26 to reputation engine 20. In either embodiments, reputation engine 20 could be located remotely on cloud 16, or alternatively, could have both a local and a cloud component, on mobile device 14.

In step 60, reputation engine 20 may analyze manifest 26 with other stored data in application manifest database 32 and/or real-time data capture module 40. The other stored data may be previously crowdsourced from a plurality of sources. Analyzing may include determining any differences between manifest 26 and the other stored data, and aggregating the differences with the other stored data; analyzing may also include aggregating information from manifest 26 with the other stored data, and determining a propagation factor of the mobile application and other trends. In an example embodiment, data mining module 34 may extract comparable information from application manifest database 32 and/or real-time data capture module 40 for comparing with manifest 26. In another example embodiment, manifest 26 may be aggregated into application manifest database 32 and/or real-time data capture module 40. Manifest 26 may be saved into application manifest database 32. Data mining module 34 may then extract substantially all relevant information (including information in manifest 26) pertaining to application 22 from application manifest database 32 and real-time data capture module 40. Reputation engine 20 may calculate a reputation score for application 22 in step 62. Calculation may be performed by any suitable means. In an example embodiment, the calculated reputation score may be an updated reputation score.

In step 64, a suitable action may be determined based on the calculated reputation score. In an example embodiment, reputation engine 20 may send the calculated reputation score to agent 24 on mobile device 14. Agent 24 may use the reputation score to determine the suitable action based on policies available on mobile device 14. In another example embodiment, reputation engine 20 may store the reputation score, which can be accessed by agent 24. Agent 24 then determines the suitable action. Suitable actions may include any action, for example, changing configuration of application 22; deleting application 22 from mobile device 14; generating a security alert on a display of mobile device 14; generating a security beep on a speaker of mobile device 14; preventing execution of application 22; preventing download of application 22 from application store 18; transmitting a security alert to application store 18; preventing access to resources in mobile device 14; quarantining mobile application 22; quarantining mobile device 14; not taking any security action, etc. The process ends in step 66.

Turning to FIG. 5, FIG. 5 is a simplified flow-chart illustrating example operational steps associated with embodiments according to the present disclosure. Embodiments of the present disclosure can calculate reputation scores for mobile applications from real-time activities and requests for resources of the mobile applications. Embodiments of the present disclosure can also enhance a reputation score for mobile applications from real-time activities and requests for resources of the mobile applications. A method 70 for calculating and/or updating a reputation score of a mobile application (e.g., application 22) may begin in step 72 when a mobile device (e.g., mobile device 14) accesses application store 18, or other source of mobile applications. In step 74, application 22 may be downloaded. In step 76, mobile device 14 may run application 22.

In an example embodiment, prior to running application 22, method 50 described in connection with FIG. 4, may be implemented, and a reputation score may be calculated. In 77, application behavior (e.g., requests for resources and application actions) may be monitored. In step 78, application behavior may be communicated to reputation engine 20. Application behavior may include application requests (e.g., requests for mobile device resources, such as access to files and pictures stored on the mobile device, access to cameras and microphones, etc.) and application actions (e.g., actions initiated by the application, such as turning on the mobile device microphone and camera, initiating a network connection with a rogue IP address, starting a virtual game of cards, etc.) In an example embodiment, agent 24 on mobile device 14 may monitor the application behavior and communicate it to real-time data capture module 40 in reputation engine 20.

In step 80, reputation engine 20 may analyze the application behavior with other stored data (e.g., previously stored data crowdsourced from a plurality of sources) in application manifest database 32 and/or real-time data capture module 40. Analyzing may include determining any differences between application behavior and other stored data, and aggregating the differences with the other stored data; analyzing may also include aggregating the application behavior with other stored data, and determining a propagation factor of the mobile application and other trends. In an example embodiment, data mining module 34 may extract comparable information from application manifest database 32 and/or real-time data capture module 40 for analyzing with application behavior. For example, data mining module 34 may seek information to determine if similar actions have been requested in the past. In another example embodiment, application behavior may be aggregated into application manifest database 32 and/or real-time data capture module 40. Data mining module 34 may then extract substantially all relevant information pertaining to application 22 from application manifest database 32 and real-time data capture module 40. Reputation engine 20 may calculate a reputation score for application 22 in step 82. Calculation may be performed by any suitable means. In an example embodiment, the calculated reputation score may be an updated (e.g., enhanced) reputation score.

In step 84, a suitable action may be determined based on the calculated reputation score. In an example embodiment, reputation engine 20 may send the calculated reputation score to agent 24 on mobile device 14. Agent 24 may use the reputation score to determine the suitable action based on policies available on mobile device 14. In another example embodiment, reputation engine 20 may store the reputation score, which can be accessed by agent 24. Agent 24 then determines the suitable action. Suitable actions may include any action, for example, changing configuration of application 22; deleting application 22 from mobile device 14; generating a security alert on a display of mobile device 14; generating a security beep on a speaker of mobile device 14; transmitting a security alert to application store 18; preventing execution of application 22; preventing download of application 22 from application store 18; preventing access to resources in mobile device 14; quarantining mobile application 22a; quarantining mobile device 14; not taking any security action, etc. The process ends in step 86.

Turning to FIG. 6, FIG. 6 is a bar chart illustrating number of applications 92 along the Y-axis versus reputation score 90 on the X-axis. Reputation score 90 may be classified into a plurality of categories. In an example embodiment, low reputation scores may be classified as low risk, and assigned a color green. Reputation scores reflecting an unverified status may be assigned a color yellow. Intermediate reputation scores may be classified as medium risk and assigned a color orange. High reputation scores may be classified as high risk and assigned a color red. For each reputation score (or range of reputation scores), there may be several corresponding applications. For example, a number of applications 92 may have an identical reputation score (or range of reputation scores), which may be different from another number of applications with a different reputation score. Suitable actions may be taken based on the risk level. For example, applications with reputation scores in the high risk category may not be allowed to download or run and an appropriate alert may be sent to the mobile device when an attempt to download or run the high-risk application is made. On the other hand, applications with reputation scores in the low risk category may be allowed to download and run. Any number of suitable actions may be taken based on the risk categories of the applications. The colors are provided for illustrative purposes only. Any other classification labels, means, schemes and methods may be used without changing the scope of the present disclosure.

Although the embodiments described herein have referred to mobile applications, it will be apparent that other sets of program files may be evaluated and/or remediated using system 10. The options for crowdsourcing of mobile application reputations, as shown in FIGURES, are for example purposes only. It will be appreciated that numerous other options, at least some of which are detailed herein in this Specification, may be provided in any combination with or exclusive of the options of the various FIGURES.

Software for achieving the operations outlined herein for crowdsourcing of mobile application reputations can be provided at various locations (e.g., the corporate IT headquarters, end user computers, web servers, distributed servers in the cloud, software security provider cloud or datacenter, etc.). In some embodiments, this software could be received or downloaded from a web server (e.g., in the context of purchasing individual end-user licenses for separate networks, devices, servers, etc.) in order to provide this system for crowdsourcing of mobile application reputations. In one example implementation, this software is resident in one or more mobile devices, computers and/or servers sought to be protected from a security attack (or protected from unwanted or unauthorized manipulations of data).

System 10 may be implemented in hardware or software, and may be used to assess mobile applications either remotely or locally. In an example embodiment, system 10 may be implemented as a cloud component and local agents on various mobile devices, wherein the local agents perform collecting information (e.g., application fingerprint information), monitoring (e.g., application behavior), and enforcing functions and the cloud component receives the application fingerprint information, determines reputation scores and pushes reputation scores back to the mobile devices. In another embodiment, system 10 may be implemented as a remote automated service that can scan a targeted mobile device according to a pre-determined schedule, for example, once every 24 hours. In yet another example embodiment, system 10 may be implemented as a portable solution that can be temporarily loaded onto a network connected to a target mobile device. System 10 may perform a deep inspection of mobile applications on myriad mobile devices. In yet another example embodiment, system 10 may be hosted on a mobile device.

In various embodiments, the software of the system for crowdsourcing of mobile application reputations could involve a proprietary element (e.g., as part of a network security solution with security management products such as McAfee® Enterprise Mobility Management), which could be provided in (or be proximate to) these identified elements, or be provided in any other device, server, network appliance, console, firewall, switch, information technology (IT) device, distributed server, etc., or be provided as a complementary solution, or otherwise provisioned in the network. In various embodiments, cloud 16 may include one or more servers running proprietary software, such as McAfee® Global Threat Intelligence (GTI) Cloud software.

In certain example implementations, the activities outlined herein may be implemented in software. This could be inclusive of software provided in reputation engine 20 and in other network elements (e.g., mobile devices 14) including mobile applications. These elements and/or modules can cooperate with each other in order to perform the activities in connection with crowdsourcing of mobile application reputations as discussed herein. In other embodiments, these features may be provided external to these elements, included in other devices to achieve these intended functionalities, or consolidated in any appropriate manner. For example, some of the processors associated with the various elements may be removed, or otherwise consolidated such that a single processor and a single memory location are responsible for certain activities. In a general sense, the arrangement depicted in FIGURES may be more logical in its representation, whereas a physical architecture may include various permutations, combinations, and/or hybrids of these elements.

In various embodiments, some or all of these elements include software (or reciprocating software) that can coordinate, manage, or otherwise cooperate in order to achieve the web application assessment operations, as outlined herein. One or more of these elements may include any suitable algorithms, hardware, software, components, modules, interfaces, or objects that facilitate the operations thereof. In the implementation involving software, such a configuration may be inclusive of logic encoded in one or more tangible media, which may be inclusive of non-transitory media (e.g., embedded logic provided in an application specific integrated circuit (ASIC), digital signal processor (DSP) instructions, software (potentially inclusive of object code and source code) to be executed by a processor, or other similar machine, etc.).

In some of these instances, one or more memory elements (e.g., memory 38) can store data used for the operations described herein. This includes the memory element being able to store software, logic, code, or processor instructions that are executed to carry out the activities described in this Specification. A processor can execute any type of instructions associated with the data to achieve the operations detailed herein in this Specification. In one example, processor 36 could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

Reputation engine 20 and other associated components in system 10 can include one or more memory elements (e.g., memory 38) for storing information to be used in achieving operations associated with crowdsourcing of mobile application reputations as outlined herein. These devices may further keep information in any suitable type of memory element (e.g., random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. The information being tracked, sent, received, or stored in system 10 could be provided in any database, register, table, cache, queue, control list, or storage structure, based on particular needs and implementations, all of which could be referenced in any suitable timeframe. Any of the memory items discussed herein should be construed as being encompassed within the broad term ‘memory element.’ Similarly, any of the potential processing elements, modules, and machines described in this Specification should be construed as being encompassed within the broad term ‘processor.’ Each of the computers may also include suitable interfaces for receiving, transmitting, and/or otherwise communicating data or information in a network environment.

Note that with the numerous examples provided herein, interaction may be described in terms of two, three, four, or more network elements and modules. However, this has been done for purposes of clarity and example only. It should be appreciated that the system can be consolidated in any suitable manner. Along similar design alternatives, any of the illustrated computers, modules, components, and elements of FIG. 1 may be combined in various possible configurations, all of which are clearly within the broad scope of this Specification. In certain cases, it may be easier to describe one or more of the functionalities of a given set of flows by only referencing a limited number of network elements. It should be appreciated that the system of FIG. 1 (and its teachings) is readily scalable and can accommodate a large number of components, as well as more complicated/sophisticated arrangements and configurations. Accordingly, the examples provided should not limit the scope or inhibit the broad teachings of system 10 as potentially applied to a myriad of other architectures.

It is also important to note that the operations described with reference to the preceding FIGURES illustrate only some of the possible scenarios that may be executed by, or within, the system. Some of these operations may be deleted or removed where appropriate, or these steps may be modified or changed considerably without departing from the scope of the discussed concepts. In addition, the timing of these operations may be altered considerably and still achieve the results taught in this disclosure. The preceding operational flows have been offered for purposes of example and discussion. Substantial flexibility is provided by the system in that any suitable arrangements, chronologies, configurations, and timing mechanisms may be provided without departing from the teachings of the discussed concepts.

What is claimed is:

1. A method comprising:
obtaining a collection of attributes of a mobile application;
analyzing one or more of the attributes with crowdsourced data associated with other mobile applications to determine one or more trustworthiness indicators; and
calculating a reputation score of the mobile application based on the one or more trustworthiness indicators.

2. The method of claim 1, wherein the one or more trustworthiness indicators include:
(a) a prevalence of the mobile application;
(b) a reputation of an application store;
(c) capabilities of the mobile application; and
(d) reputation scores of other mobile applications from a same signer.

3. The method of claim 1, wherein the collection of attributes comprises at least one of: a manifest; and an application behavior.

4. The method of claim 3, wherein the manifest comprises one or more of a unique application identification (ID) tag; an application certificate; an application name; an application capability; an application life span; ports and protocols usable by the mobile application;
network activity; attack history; association with other known Internet Protocol (IP) addresses;
files and file hashes associated with the mobile application; and country or region where the mobile application is currently located.

5. The method of claim 1, further comprising determining a suitable action based on the reputation score.

6. The method of claim 5, wherein the suitable action comprises at least one of:
(a) changing a configuration of the mobile application;
(b) deleting the mobile application from a mobile device;
(c) generating a security alert on a display of the mobile device;
(d) generating a security beep on a speaker of the mobile device;
(e) transmitting a security alert to an application store;
(f) preventing execution of the mobile application;
(g) preventing download of the mobile application from the application store;
(h) preventing access to resources in the mobile device;
(i) quarantining the mobile application;
(j) quarantining the mobile device; and
(k) not taking any security action.

7. The method of claim 1, further comprising:
determining a propagation factor of the mobile application,
wherein the collection of attributes includes at least one application capability and wherein the crowdsourced data includes the propagation factor and a geographical location of an origination of the mobile application.

8. An apparatus comprising:
a memory element configured to store data; and
a computing processor operable to execute instructions associated with the data;
a data mining module;
a real-time data capture module; and
an application manifest database, wherein the apparatus is configured for:
obtaining a collection of attributes of a mobile application;
analyzing one or more of the attributes with crowdsourced data associated with other mobile applications to determine one or more trustworthiness indicators; and
calculating a reputation score of the mobile application based on the one or more trustworthiness indicators.

9. The apparatus of claim 8, wherein the one or more trustworthiness indicators include:
(a) a prevalence of the mobile application;
(b) a reputation of an application store;
(c) capabilities of the mobile application; and
(d) reputation scores of other mobile applications from a same signer.

10. The apparatus of claim 8, wherein the collection of attributes comprises at least one of: a manifest; and an application behavior.

11. The apparatus of claim 10, wherein the manifest comprises: one or more of a unique application identification (ID) tag; an application certificate; an application name; an application capability; an application life span; ports and protocols useable by the mobile application; network activity; attack history; association with other known Internet Protocol (IP) addresses; files and file hashes associated with the mobile application; and country or region where the mobile application is currently located.

12. The apparatus of claim 8, wherein the apparatus is further configured for:
determining a suitable action based on the reputation score.

13. The apparatus of claim 12, wherein the suitable action comprises at least one of:
(a) changing a configuration of the mobile application;
(b) deleting the mobile application from a mobile device;
(c) generating a security alert on a display of the mobile device;
(d) generating a security beep on a speaker of the mobile device;
(e) transmitting a security alert to an application store;
(f) preventing execution of the mobile application;
(g) preventing download of the mobile application from the application store;
(h) preventing access to resources in the mobile device;
(i) quarantining the mobile application;
(j) quarantining the mobile device; and
(k) not taking any security action.

14. Logic encoded in non-transitory media that includes code for execution and when executed by a processor is operable to perform operations comprising:
obtaining a collection of attributes of a mobile application;
analyzing one or more of the attributes with crowdsourced data associated with other mobile applications to determine one or more trustworthiness indicators; and
calculating a reputation score of the mobile application based on the one or more trustworthiness indicators.

15. The logic of claim 14, wherein the one or more trustworthiness indicators include:
(a) a prevalence of the mobile application;
(b) a reputation of an application store;
(c) capabilities of the mobile application; and
(d) reputation scores of other mobile applications from a same signer.

16. The logic of claim 14, wherein the collection of attributes comprises at least one of: a manifest; and an application behavior.

17. The logic of claim 16, wherein the manifest comprises: one or more of a unique application identification (ID) tag; an application certificate; an application name; an application capability; an application life span; ports and protocols useable by the mobile application; network activity; attack history; association with other known Internet Protocol (IP) addresses; files and file hashes associated with the mobile application; and country or region where the mobile application is currently located.

18. The logic of claim 14, the processor being operable to perform further operations comprising:
determining a suitable action based on the reputation score.

19. The logic of claim 18, wherein the suitable action comprises at least one of:
(a) changing a configuration of the mobile application;
(b) deleting the mobile application from a mobile device;
(c) generating a security alert on a display of the mobile device;
(d) generating a security beep on a speaker of the mobile device;
(e) transmitting a security alert to an application store;
(f) preventing execution of the mobile application;
(g) preventing download of the mobile application from the application store;
(h) preventing access to resources in the mobile device;
(i) quarantining the mobile application;
(j) quarantining the mobile device; and
(k) not taking any security action.

20. The logic of claim 14, further comprising:
determining a propagation factor of the mobile application,
wherein the collection of attributes includes at least one application capability and wherein the crowdsourced data includes the propagation factor and a geographical location of an origination of the mobile application.
